(19) United States
(12) Patent Application Publication
(10) Pub. No.: US 2006/0228192 A1
(43) Pub. Date: Oct. 12, 2006

(54) Fastening member

(75) Inventor: Jen-Kui Chang, (US)

Correspondence Address: FULBRIGHT AND JAWORSKI LLP, 555 S. FLOWER STREET, 41ST FLOOR, LOS ANGELES, CA, 90071, US

(73) Assignee: Evening Star International, Inc.

(21) Appl. No.: 11/329,357

(22) Filed: Jan. 9, 2006

Related U.S. Application Data
(63) Continuation-in-part of application No. 10/788,551, filed on Feb. 26, 2004, now abandoned.

(51) Int. Cl. F16B 15/00

(52) U.S. Cl. 411/451.3; 411/477

(57) ABSTRACT

A fastening member includes a root portion, and a driven portion. The root portion has a first end and a second end and has a mediate portion formed with two elongated slots. The driven portion has an end extended from the first end of the root portion so that the root portion is combined with the driven portion to form a substantially L-shaped body. The root portion is arcuate between the elongated slots and a flat tip portion defining a penetrating point thus providing flat outer edges and flat tip.

### CROSS-REFERENCE TO RELATED APPLICATION

This application is a continuation-in-part of patent application Ser. No. 10/788,551 filed on Feb. 26, 2004, which is hereby incorporated by reference into this application.

### BACKGROUND OF THE INVENTION

1. Field of the Invention

The present invention relates to a fastening member, and more particularly to a fastening member that is combined with the workpieces rigidly and stably without detachment, so that the workpieces are closely combined together.

2. Description of the Related Art

A conventional fastening member, such as a nail or the like, is used to combine two workpieces together. Usually, the conventional fastening member comprises a bar-shaped shank having a sharp point, and a disk-shaped head mounted on the shank. The shank is located at a center of the head. Thus, the conventional fastening member form a substantially T-shaped structure. However, the shank of the conventional fastening member has a smooth surface, so that the shank is easily detached from the two combined workpieces, thereby detaching the two workpieces.

### SUMMARY OF THE INVENTION

The present invention is to mitigate and/or obviate the disadvantage of the conventional fastening member.

The primary objective of the present invention is to provide a fastening member that is combined with the workpieces rigidly and stably without detachment, so that the workpieces are closely combined together.

Another objective of the present invention is to provide a fastening member, wherein the root portion has a first face formed with a convex arc-shaped surface and a second face formed with a concave arc-shaped surface, so that the fastening member has an enhanced structural strength.

A further objective of the present invention is to provide a fastening member, wherein the ratchet portions of the root portion are closely engaged with the workpieces to prevent the fastening member from detaching from the workpieces.

In accordance with the present invention, there is provided a fastening member, comprising a root portion, and a driven portion, wherein:

the root portion has a first end and a second end, the root portion has a mediate portion formed with two elongated slots; and

the driven portion has an end extended from the first end of the root portion.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a fastening member in accordance with the preferred embodiment of the present invention;

FIG. 2 is a plan cross-sectional view of the fastening member taken along line 2-2 as shown in FIG. 1;

FIG. 3 is a perspective assembly view showing the fastening member being combined with two articles;

FIG. 4 is a plan cross-sectional view of the fastening member and the two articles as shown in FIG. 3;

FIG. 5 is a plan cross-sectional view of the fastening member and the two articles as shown in FIG. 3;

FIG. 6 is a schematic operational view of the fastening member as shown in FIG. 5;

FIG. 7 is a partially enlarged view of the fastening member as shown in FIG. 6.

FIG. 8 is a perspective view of an alternative embodiment of fastening member of the present invention;

FIG. 9 is a cross sectional view taken about the lines 9-9 of FIG. 8;

FIG. 10 is a cross sectional view taken about the lines 10-10 of FIG. 8;

FIG. 11 is a front elevational view of the fastener as shown in FIG. 8; and

FIG. 12 is a cross sectional view taken about the lines 12-12 of FIG. 11.

### DETAILED DESCRIPTION OF THE INVENTION

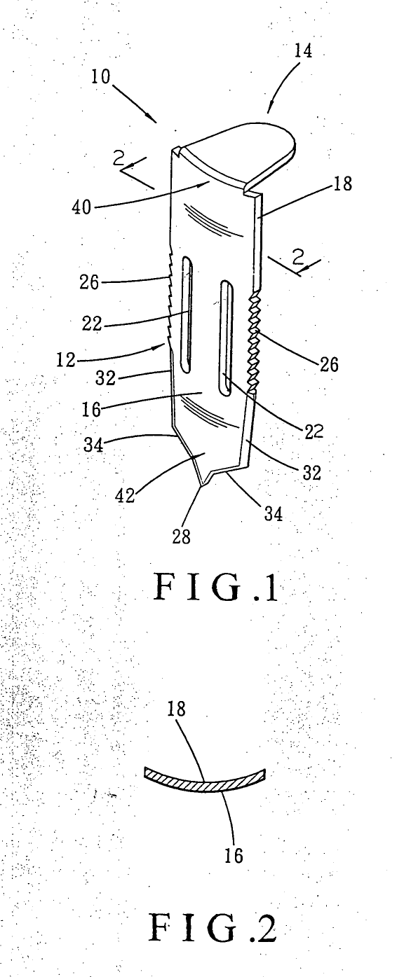

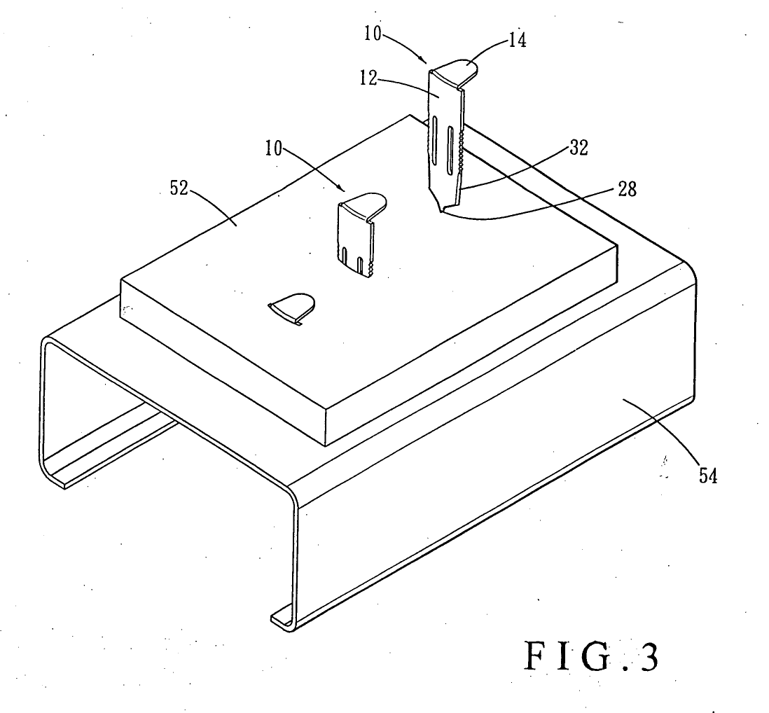

Referring to the drawings and initially to FIGS. 1-3, a fastening member 10 in accordance with the preferred embodiment of the present invention comprises a root portion 12 and a driven portion 14.

The root portion 12 is a sheet plate and has a first end 40 and a second end 42. The root portion 12 has a first face formed with a convex arc-shaped surface 16 and a second face formed with a concave arc-shaped surface 18. Thus, the root portion 12 has an enhanced structural strength. The root portion 12 has a mediate portion formed with two elongated slots 22. Each of the two elongated slots 22 is extended along a longitudinal direction of the root portion 12. The root portion 12 has two opposite sides each formed with a ratchet portion 26. The ratchet portion 26 of each of the two opposite sides of the root portion 12 is directed toward the first end 40 of the root portion 12. The second end 42 of the root portion 12 has two opposite sides each formed with an inclined face 32 having a first end located adjacent to the respective ratchet portion 26, an oblique blade 34 having a first end extended from a second end of the inclined face 32, and a tip 28 extended from a second end of the oblique blade 34. The inclined faces 32 of the two opposite sides of the second end 42 of the root portion 12 have a width smaller that that of the root portion 12.

The driven portion 14 has a planar shape and has an end extended from the first end 40 of the root portion 12. The driven portion 14 is vertical to the root portion 12, so that the root portion 12 is combined with the driven portion 14 to form a substantially L-shaped body.

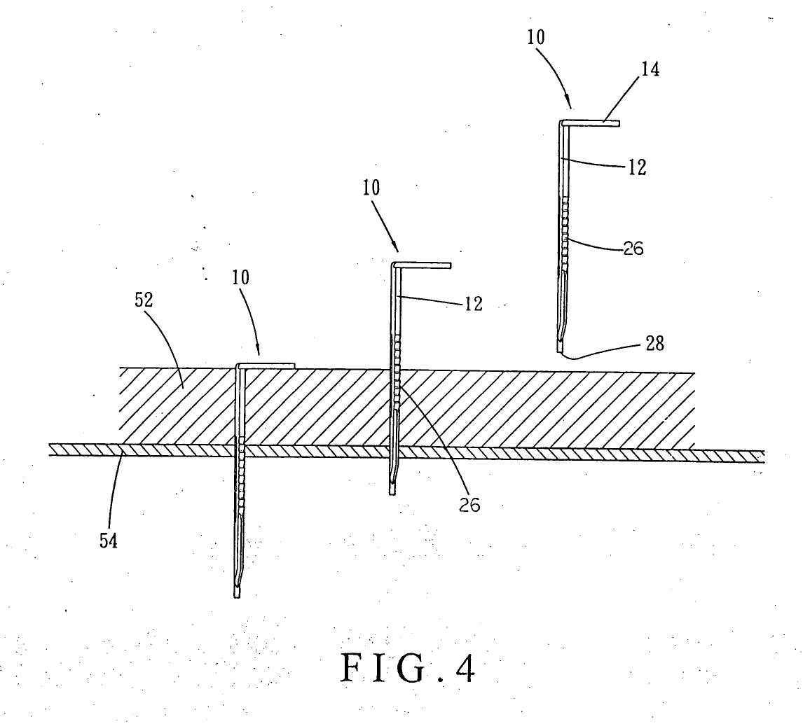

In operation, referring to FIGS. 1-7, the fastening member 10 is used to combine two articles 52 and 54 together. The two articles 52 and 54 are juxtaposed with each other. Then, the tip 28 of the root portion 12 of the fastening member 10 is rested on the article 52, and a striking force is applied on the driven portion 14 of the fastening member 10 by a hammer or the like, to in turn force the tip 28 of the root portion 12 of the fastening member 10 into the article 52 and the article 54.

At this time, the oblique blades 34 of the root portion 12 of the fastening member 10 are guided by the tip 28 to move with the root portion 12 so as to cut the articles 52 and 54 successively, so that the root portion 12 of the fastening member 10 is moved in the articles 52 and 54 smoothly and conveniently.

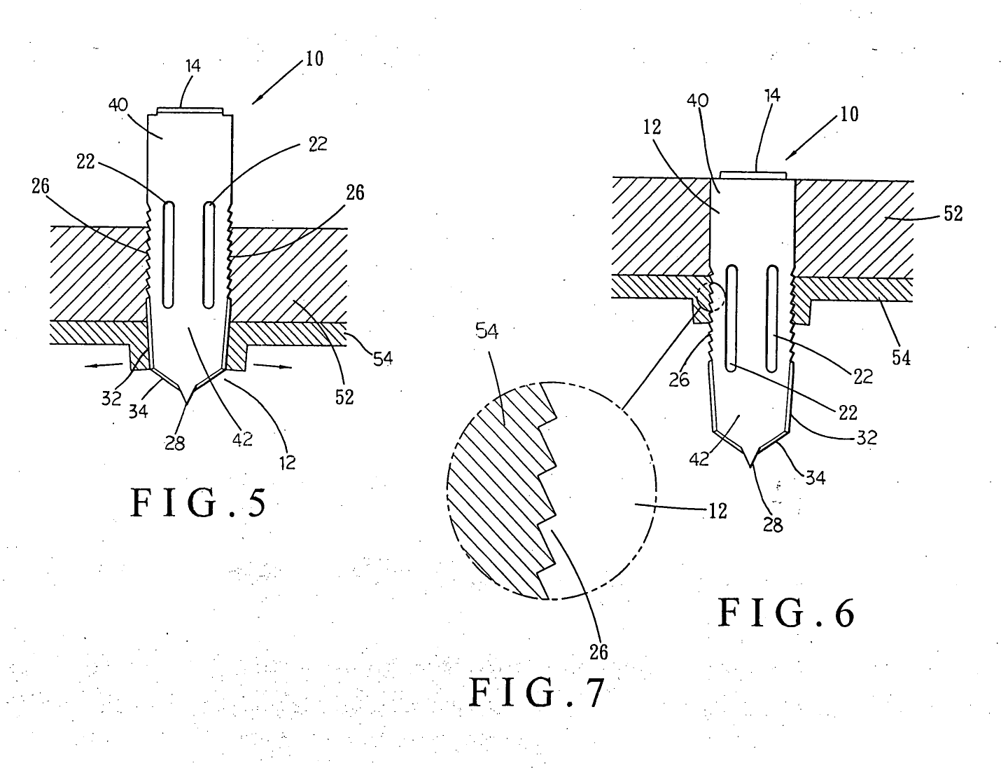

After the root portion 12 of the fastening member 10 is forced into the articles 52 and 54 as shown in FIG. 5, the root portion 12 of the fastening member 10 is elastically compressed inward by provision of the two elongated slots 22 S reduce the width of the root portion 12 of the fastening member 10, so that the root portion 12 of the fastening member 10 is moved in the articles 52 and 54 easily and conveniently. In addition, the inclined faces 32 facilitates movement of the root portion 12 of the fastening member 10 in the articles 52 and 54.

After the second end 42 of the root portion 12 of the fastening member 10 is detached from the articles 52 and 54 as shown in FIG. 6, the root portion 12 of the fastening member 10 is elastically expanded outward by provision of the two elongated slots 22 to restore the width of the root portion 12 of the fastening member 10, so that the root portion 12 of the fastening member 10 is combined with the articles 52 and 54 rigidly and stably. In addition, the ratchet portions 26 of the root portion 12 are directed toward the first end 40 of the root portion 12 as shown in FIG. 7 to engage the articles 52 and 54 closely to prevent the root portion 12 from moving back in the articles 52 and 54, so that the root portion 12 of the fastening member 10 is combined with the articles 52 and 54 rigidly and stably without detachment.

Although the fastener as shown in the embodiment of FIGS. 1-7 functions to perform the desired result it has been found that by rearranging a portion of the wood portion that a more effective fastener is obtained. The improved fastener has the arcuate portion having the convex and concave surfaces formed such that the apex of the arcuate surface is centered along the midline of the root portion of the fastener body. The arcuate portion diminishes outwardly toward the outside edges until it reaches a line extending along the length of the root portion at the outside edges of the elongated slots. Beyond this point the sides of the root portion of the fastener body are substantially flat. Such construction allows the side edges of the fastener body to function as guides internally in a power driven tool to maintain the fastener body perpendicular to the workpiece while it is been driven into and through the workpiece. The arcuate part of the body extends along the longitudinal axis of the body from the driven portion to that portion where the formation of the point commences. The point area also is substantially flat as are the side portions of the fastener body. This structure allows a more efficient and effective entry of the fastener into the workpiece while at the same time permitting the arcuate shaped portion of the fastener body to provide increased contact and pressure of the surrounding metal with the fastener to thereby retain the fastener firmly and permanently in place in the workpieces.

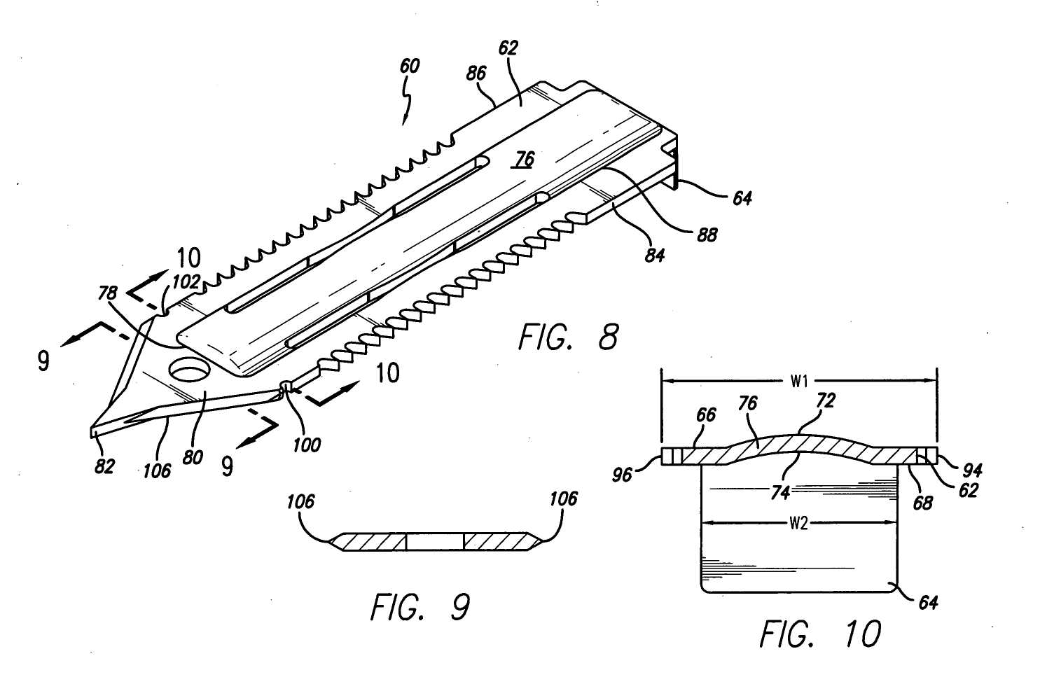

By referring now to FIGS. 8-12 there is illustrated in greater detail the fastener of the present invention in its alternative embodiment. The fastener 60 includes a body portion 62 and a head 64 which is used by a power tool (not shown) to drive the fastener 60 through the workpieces. The body 62 has a width dimension W1 while the head 64 has a width dimension W2. The width dimension W2 of the head is less than the width dimension W1 of the body 62 so that the outer edges 66 and 68 of the body 62 are flat and provide guide rails for the fastener so that it is retained in a perpendicular position relative to the workpieces while it is been driven into place in the workpieces by the power tool. The body 62 has a longitudinal axis 70. The body 62 along the longitudinal axis 70 has a convex surface 72 and concave surface 74 as viewed in FIG. 10 thereby providing an arcuate body shape 76 which extends along the longitudinal axis 70 from the head 64 to a point 78 which is the area 80 of the fastener body where the penetrating point 82 of the fastener commences.

As can be seen particularly in FIGS. 8 and 10, the arcuate body portion 76 diminishes outwardly toward the side edges 84 and 86 to a coining line 88 which extends from the head 64 along both sides of the body 62 and around the bottom area of the arcuate portion to the point 78. Another way of viewing this is that the coined portion of the sides of the fastener body 62 extend inwardly from the edges 84 and 86 to the coining line 88 at which point the arcuate section 76 of the body 62 commences. Thus, the flat portions of the body at the point and the two side edges fair into a smooth transition into the arcuate portion 76 of the body 62.

A pair of elongated slots 90 and 92 fully enclosed by the body 62 of the fastener are displaced inwardly from the side edges 86 and 84 of the body respectively. The outer edge 84 and 86 of the body 62 are formed with ratchet portions or teeth 94 and 96 used to lock the fastener into place in the workpieces as above described. It will be recognized by those schooled in the art that as the fastener penetrates through a metal substrate forces are generated which will cause the sides to move inwardly as the ratchet teeth 94 and 96 engage the substrate. To prevent these forces from moving the fastener body inwardly to a degree sufficient to impair the memory of the metal, there is provided a narrowed down or diminished width region of the elongated slots as shown at 98 over the approximately central one-third of the elongated openings which function as a stop to limit travel of the sides of the fastener inwardly in the elongated slots 90 and 92.

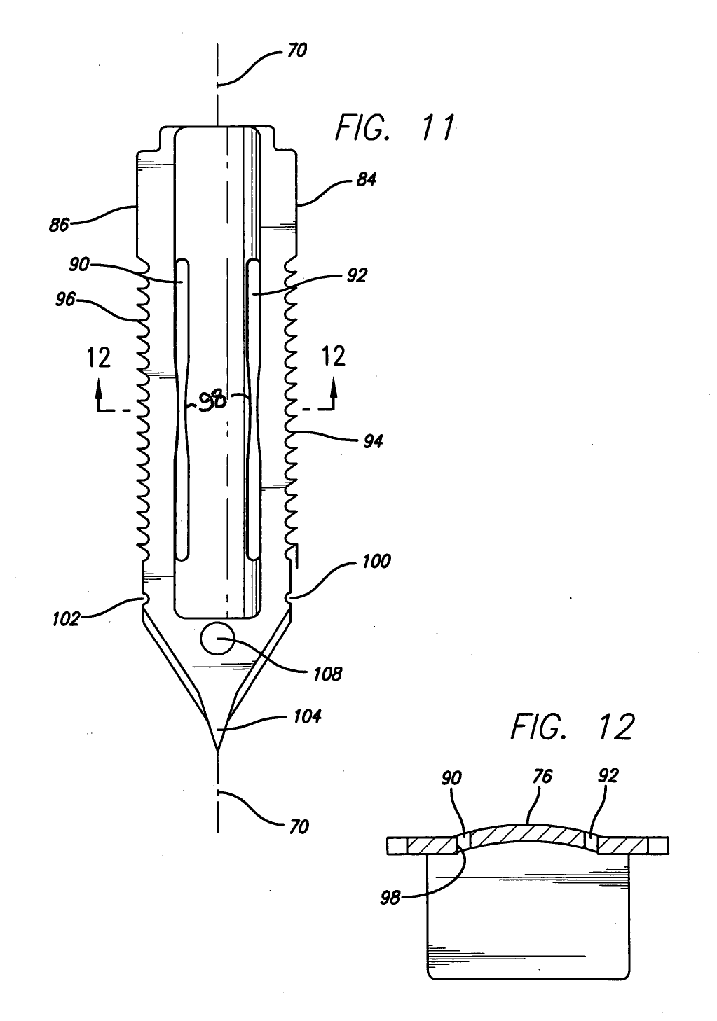

At the transition between the point area 80 to the flat sides 66 and 68, the side edges 84 and 86 define inwardly directed notches 100 and 102 respectively. It has been found that in fasteners of the type shown in this invention that as the fastener travels through the metal substrate the fastener will move the metal of the substrate sufficiently away from the edges of the fastener that sufficient material does not exist when the fastener is finally seated to cause the fastener to permanently secure the workpieces together. Through the utilization of the notches 101 and 102, it has been found that as the fastener travels through the metal substrate the substrate will first move into the notches 100 and 102 and from there along the side edge and then into the ratchet teeth 94 and 96. It should also be noted and as more particularly illustrated in FIG. 11 that the width of the body 62 over the area from the transition between the point portion and the arcuate section up to the beginning of the teeth of the ratchets 94 and 96 is slightly less than the width of the body W1. This reduction in width of the body along with the notches 100 and 102 work together to provide sufficient material remaining in the substrate for the teeth on the ratchets 94 and 96 to engage thus providing a much greater pull out factor thereby causing the fastener to securely and permanently hold the workpieces together.

It has been noted that when a fastener of the type disclosed in this application is driven through a metal substrate with a power tool that the metal substrate will tend to deflect as the fastener strikes it. It has also been found that the maximum driving force is utilized and required to initiate the penetration of the fastener into the substrate. That is in making the first hole in the metal substrate with the fastener requires more force than the continuation of forming the opening subsequent to that point in time. As a result the improved fastener shown in the alternative embodiment provides a fastener having a very sharp point for penetrating the metal substrate. The point 82 as shown more clearly in FIG. 11 includes a pilot point 104 which is very sharp and can easily penetrate the metal substrate. Shortly after the pilot point 104 penetrates the substrate, the outer edges of the region 80 which forms the point 82 are beveled as shown at 106 with the bevel commencing relatively close to the end of the pilot point 104. This bevel then allows the fastener to begin to slice open the metal substrate to allow entry of the balance of the fastener to secure the workpieces together. By utilization of a very sharp pilot point and the bevel 106 creates less deflection to the metal substrate when the fastener impacts the substrate. It should also be noted that the region 80 where the point is formed is also flat as are the regions 66 and 68 along the sides of the fastener body. Being flat also creates less resistance than if the body were arcuately shaped as it is in the arcuate region 76.

There is also provided an opening 108 which is an indexing opening for use during manufacture of the fasteners of the present invention for use in progressive dye stamping.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A fastener for securing a work piece to a metal substrate with a power tool comprising:
an elongated body having a longitudinal axis and including a point for penetrating said work piece and said substrate and having a width dimension and first and second outer edges;
a securing member carried by said body;
a head at one end of said body having a width dimension and being disposed at a substantially right angle to said body for use in driving said fastener through said work piece and said substrate;
said width dimension of said body being greater than the width dimension of said head to provide first and second flat guide rails along said first and second outer edges for cooperation with said power tool to retain said longitudinal axis perpendicular to said work piece during the time said power tool drives said fastener through said work piece and metal substrate; and
said body having an arcuate portion disposed between said flat side rails, said arcuate body portion extending from said head to an area adjacent said point.

2. A fastener as defined in claim 1 wherein said body is coined adjacent to but displaced from said outer edges of said body along a transition between said arcuate body portion and said flat guide rails.

3. A fastener as defined in claim 2 wherein said securing member includes first and second elongated completely enclosed slots disposed inwardly from said first and second outer edges respectively and said first and second outer edges define a plurality of teeth coextensive with said first and second slots, respectively.

4. A fastener as defined in claim 3 wherein the width dimension of said body between said teeth and said point is less than the width dimension of the remaining portion thereof.

5. A fastener as defined in claim 4 wherein said first and second outer edges defines a first and second notch respectively disposed between said point and said teeth.

6. A fastener as defined in claim 2 wherein said point includes a metal penetrating pilot portion followed by beveled side edges.

7. A fastener as defined in claim 2 wherein each of said first and second slots have diminished width over a central portion thereof to limit the inward travel of said outer edges during insertion of said fastener into work pieces.
